(19) United States
(12) Patent Application Publication
(10) Pub. No.: US 2023/0196583 A1
(43) Pub. Date: Jun. 22, 2023

(54) SYSTEMS AND METHODS TO PROCESS ELECTRONIC IMAGES TO IDENTIFY ABNORMAL MORPHOLOGIES

(71) Applicant: PAIGE.AI, INC., New York, NY (US)

(72) Inventors: Ran GODRICH, New York, NY (US); Christopher KANAN, Pittsford, NY (US)

(21) Appl. No.: 18/051,352

(22) Filed: Oct. 31, 2022

Related U.S. Application Data
(60) Provisional application No. 63/290,708, filed on Dec. 17, 2021.

(51) Int. Cl. G06T 7/194; G06T 7/00

(52) U.S. Cl. CPC G06T 7/194; G06T 7/0014; G06T 2207/30024; G06T 2207/20084; G06T 2207/20081

(57) ABSTRACT

Systems and methods for identifying morphologies present in digital whole slide images. The method may include receiving one or more digital whole slide images associated with a patient; determining a plurality of foreground tiles within the one or more digital whole slide images associated with a patient; determining, using a trained machine learning model, whether each foreground tile of the plurality of foreground tiles contains a known morphology or an unknown morphology; upon determining that one or more foreground tiles contains an unknown morphology, providing the one or more foreground tiles with an unknown morphology to a clustering algorithm, the clustering algorithm associating each of the one or more tiles with an unknown morphology cluster; and based on the associated unknown morphology cluster, predicting at least one outcome for the patient.

### CROSS-REFERENCE TO RELATED APPLICATIONS

This patent application claims the benefit of U.S. Provisional Application No. 63/290,708, filed on Dec. 17, 2021, the entirety of which is incorporated by reference herein.

### FIELD OF THE DISCLOSURE

Various techniques of the present disclosure pertain generally to electronic image processing. More specifically, particular techniques of the present disclosure relate to systems and methods for processing electronic images to determine rare or unknown morphologies.

### INTRODUCTION

Tissue types, whether typical or atypical, generally display characteristic histological patterns. Pathologists who study these patterns have found a number that occur with some frequency, particularly in cancer histology, and some of these patterns are associated with clinical outcomes. While many patterns have already been established, new morphological patterns have been found over time. New or rare morphological patterns are often found only when a pathologist serendipitously notices a pattern that occurs across some fraction of patients. However, discovering new patterns in this way is difficult, unstructured, inefficient, and relies on a significant amount of chance in a pathologist noticing the pattern.

The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for processing electronic images to identify morphologies. Each of the aspects of the disclosure herein may include one or more of the features described in connection with any of the other disclosed aspects.

A method for identifying morphologies present in digital whole slide images may be described. The method may include receiving one or more digital whole slide images associated with a patient; determining a plurality of foreground tiles within the one or more digital whole slide images associated with a patient; determining, using a trained machine learning model, whether each foreground tile of the plurality of foreground tiles contains a known morphology or an unknown morphology; upon determining that one or more foreground tiles contains an unknown morphology, providing the one or more foreground tiles with an unknown morphology to a clustering algorithm, the clustering algorithm associating each of the one or more tiles with an unknown morphology cluster; and based on the associated unknown morphology cluster, predicting at least one outcome for the patient.

A system for identifying morphologies present in digital medical images may be described. The system may include a processor and a memory coupled to the processor and storing instructions that, when executed by the processor, cause the processor to perform operations. The operations may include receive one or more digital whole slide images associated with a patient; determine a plurality of foreground tiles within the one or more digital whole slide images associated with a patient; determine, using a machine learning model, whether each foreground tile of the plurality of foreground tiles contains a known morphology or an unknown morphology; upon determining that one or more foreground tiles contains an unknown morphology, provide the one or more foreground tiles with an unknown morphology to a clustering algorithm, the clustering algorithm associating each of the one or more tiles with an unknown morphology cluster; and based on the associated unknown morphology cluster, predict at least one outcome for the patient.

A non-transitory computer-readable medium may store instructions that, when executed by a processor, cause the processor to perform operations for identifying morphologies present in digital medical images may be described. The operations may include receiving one or more digital whole slide images associated with a patient; determining a plurality of foreground tiles within the one or more digital whole slide images associated with a patient; determining, using a machine learning model, whether each foreground tile of the plurality of foreground tiles contains a known morphology or an unknown morphology; upon determining that one or more foreground tiles contains an unknown morphology, providing the one or more foreground tiles with an unknown morphology to a clustering algorithm, the clustering algorithm associating each of the one or more tiles with an unknown morphology cluster; and based on the associated unknown morphology cluster, predicting at least one outcome for the patient.

It is to be understood that both the foregoing general description and the following detailed description are exemplary and explanatory only and are not restrictive of the disclosed embodiments, as claimed.

### BRIEF DESCRIPTION OF THE FIGURES

The accompanying drawings, which are incorporated in and constitute a part of this specification, illustrate various exemplary techniques and together with the description, serve to explain the principles of the disclosed techniques.

FIG. 1A depicts an exemplary system for processing electronic images to identify morphologies, according to one or more techniques.

FIG. 1B depicts an exemplary system for characterizing digital whole slide images, according to one or more techniques.

FIG. 10 depicts an exemplary system for analyzing digital whole slide images, according to one or more techniques.

FIG. 2 depicts a flow chart for an exemplary method of processing electronic images to identify morphologies, according to one or more techniques.

FIG. 3 depicts a flow chart for an exemplary method of training a machine learning system to determine known and unknown patterns, according to one or more techniques.

FIG. 4 depicts a schematic for predicting an outcome using rare and unknown morphologies, according to one or more techniques.

FIG. 5 depicts a flow chart for an exemplary method for clustering digital medical images to predict normal and abnormal morphologies using pathologist annotation and active learning, according to one or more techniques.

FIG. 6 depicts a flow chart for an exemplary method for training a machine learning system to predict normal and abnormal morphologies, according to one or more techniques.

FIG. 7 depicts a schematic for filtering to abnormal foreground tiles for faster training of downstream genomics H&E-based tasks, according to one or more techniques.

FIG. 8 depicts a schematic for using cluster labels to train a classifier when label logic is limited, according to one or more techniques.

FIG. 9 depicts a flow diagram for an exemplary method of processing electronic images to identify morphologies using supervised learning with strong annotations, according to one or more techniques

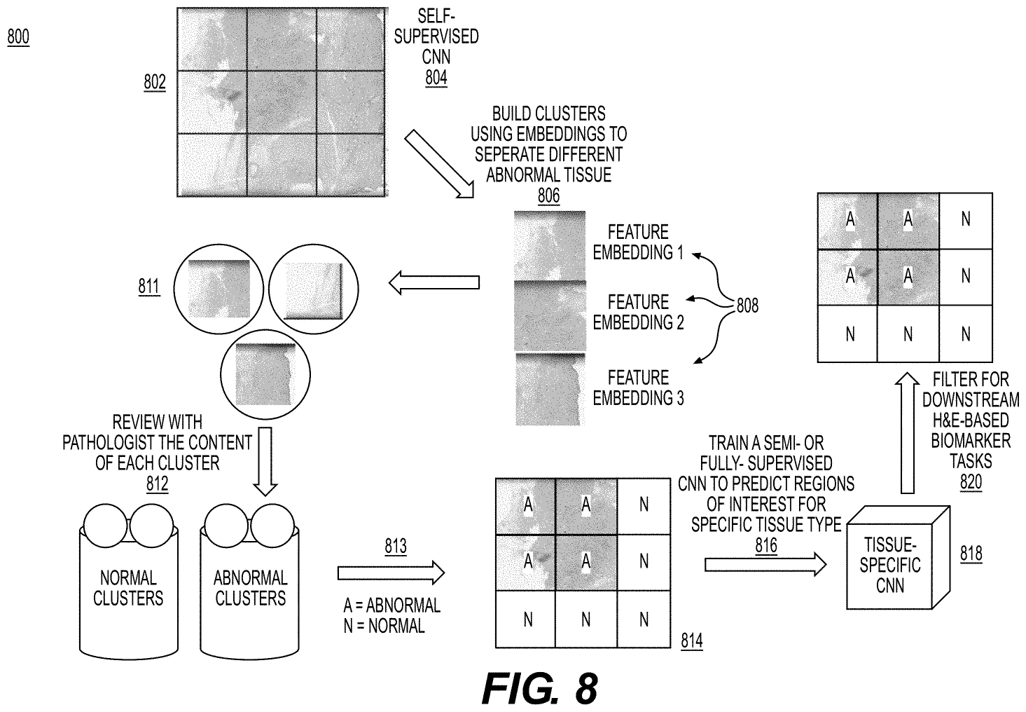

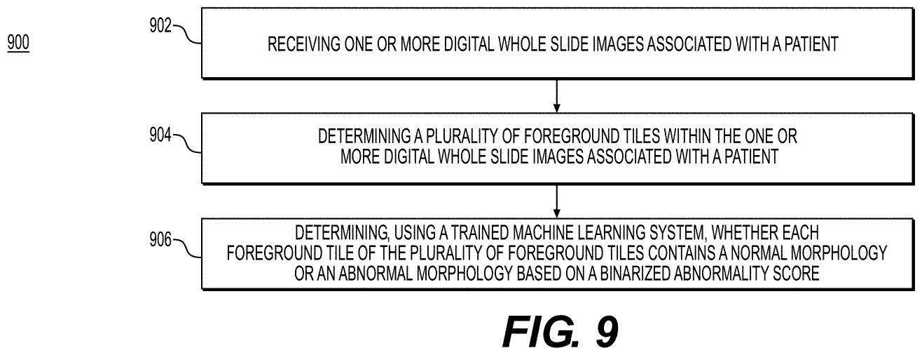

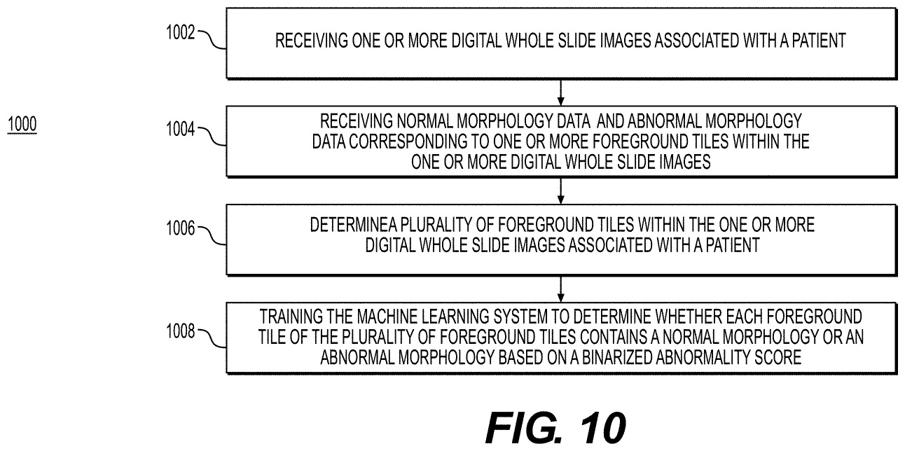

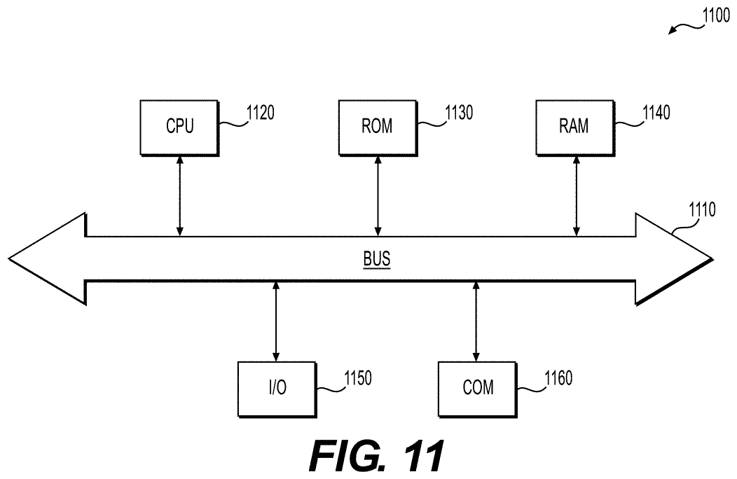

FIG. 10 depicts a flow chart for an exemplary method for training a machine learning system using supervised learning and strong annotations, according to one or more embodiments.

FIG. 11 depicts a simplified functional block diagram of a computer, according to one or more techniques.

### DETAILED DESCRIPTION

Reference will now be made in detail to the exemplary techniques of the present disclosure, examples of which are illustrated in the accompanying drawings. Wherever possible, the same reference numbers will be used throughout the drawings to refer to the same or like parts.

The systems, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these devices, systems, or methods unless specifically designated as mandatory.

Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

As used herein, the term “exemplary” is used in the sense of “example,” rather than “ideal.” Moreover, the terms “a” and “an” herein do not denote a limitation of quantity, but rather denote the presence of one or more of the referenced items.

As noted above, discovering new tissue patterns may be difficult, unstructured, inefficient, and relies on a significant amount of chance in a pathologist noticing the pattern. The present disclosure describes finding rare or unknown patterns for review by pathologists or by artificial intelligence (AI) systems and correlating these patterns to patient data, e.g., patient outcomes. Thus, certain techniques described herein may help to improve diagnosis, treatment, and/or clinical predictions for a disease.

In addition, it may be difficult to obtain data for rare cancers or know exactly what rare cancer data may be needed for training a classifier. Therefore, certain techniques described herein may help to identify rare cancers by identifying abnormalities in the data (e.g., using whole slide images (WSIs)). This identification may be performed with various unsupervised learning methods since labels for normal and abnormal tissue may not be included in a data set.

Further, pathologists may only be able to annotate a classification on a slide based on their training. Likewise, certain artificial intelligence (AI) systems may only be trained with supervised learning, in general, to detect or classify known findings in the clinical setting. Therefore, an advantage of certain techniques may be identification of rare and unknown morphologies in a repository of histopathology data such that they can be reviewed, e.g., by pathologists or biologists, for unknown or abnormal patterns and/or to gain greater insights into the disease. Certain techniques, e.g., clustering, may find these unknown or abnormal patterns. Certain techniques may also be used to speed up supervised learning or may be used for other applications.

Certain techniques may use AI to classify each region of a slide based on an abnormality of tissue within each local region of the slide. Various example techniques are described below.

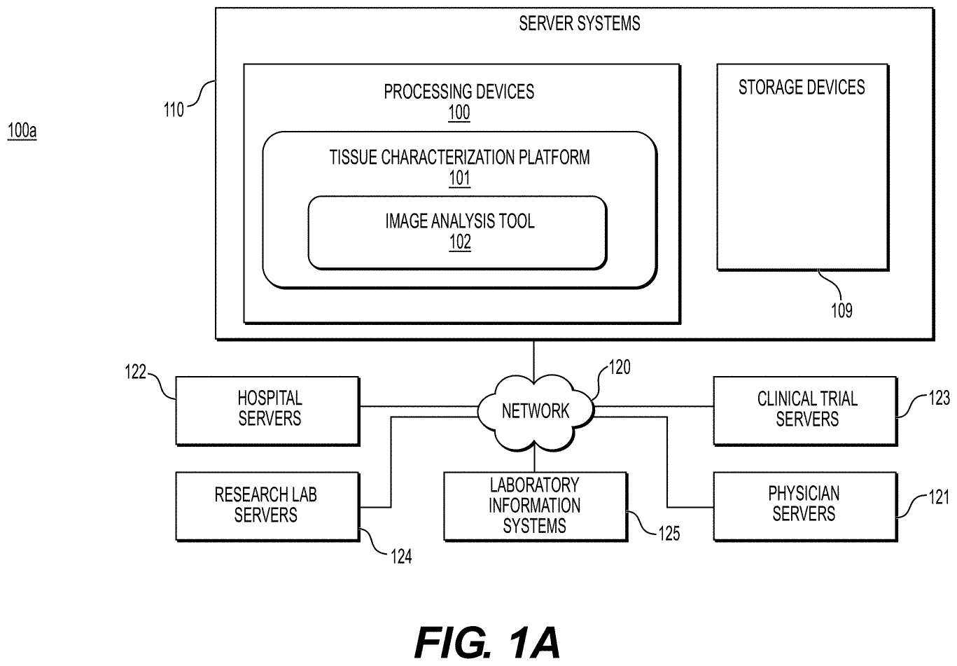

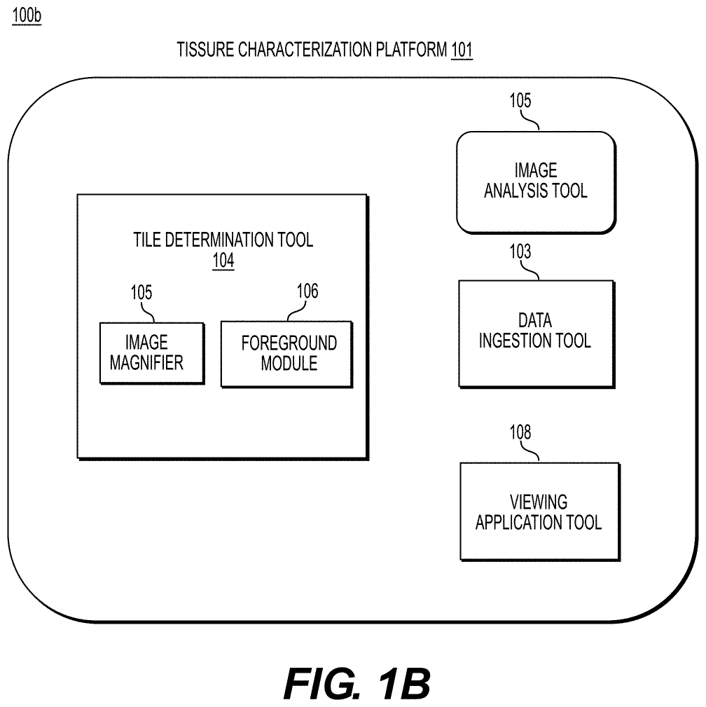

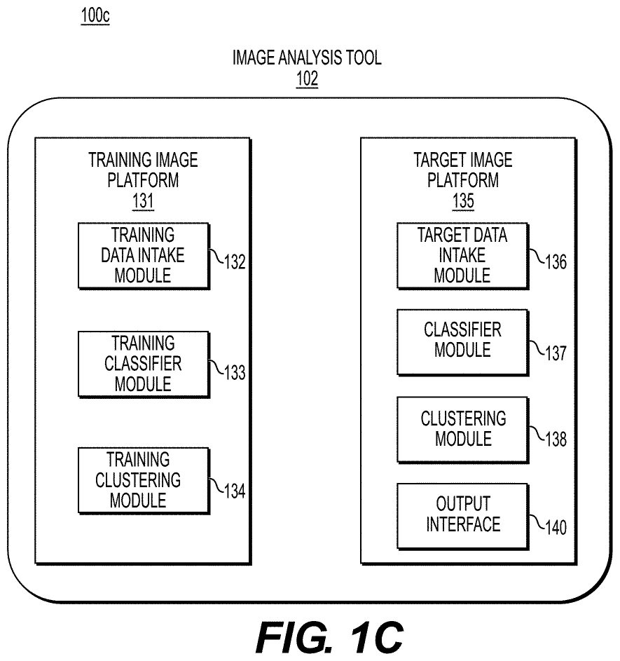

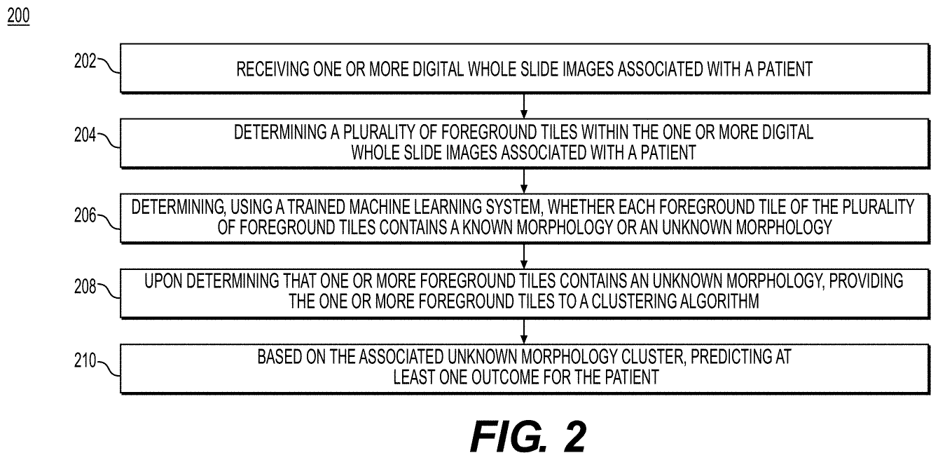

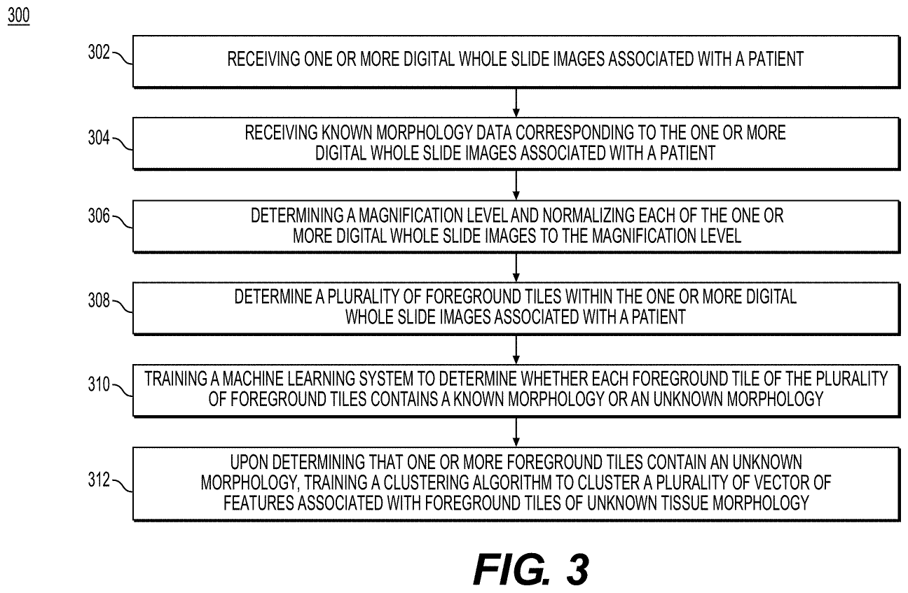

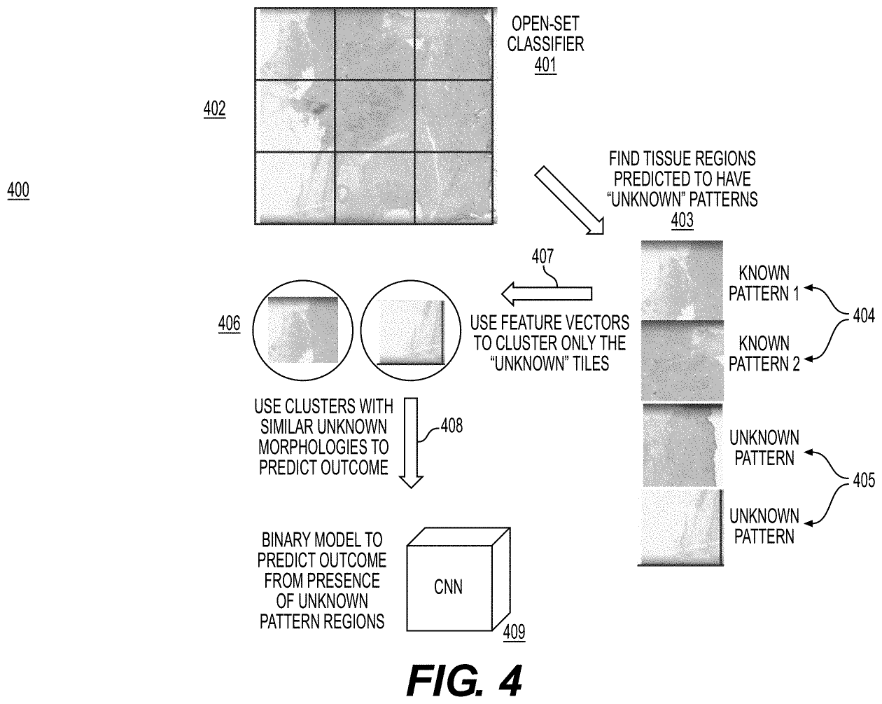

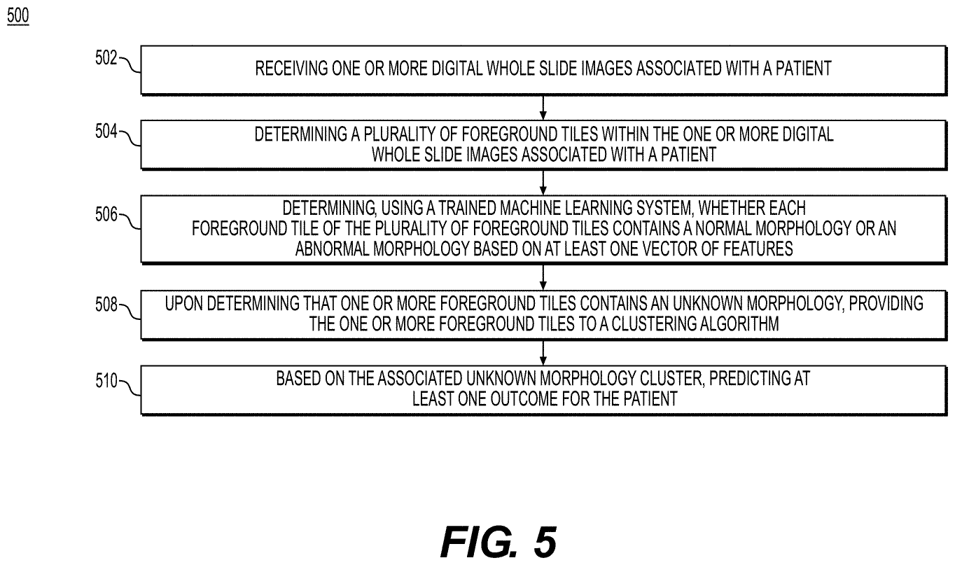

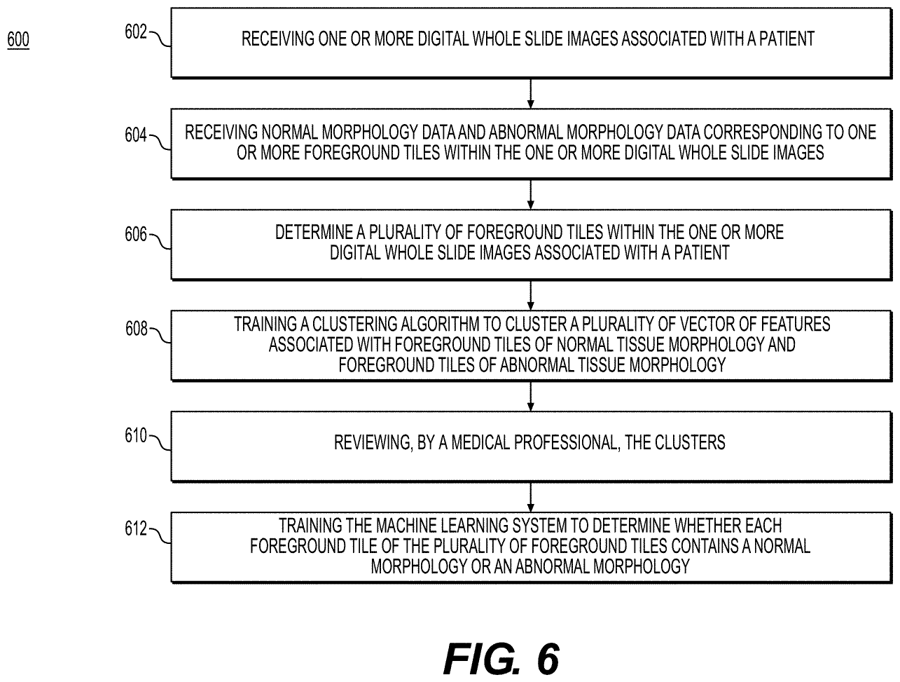

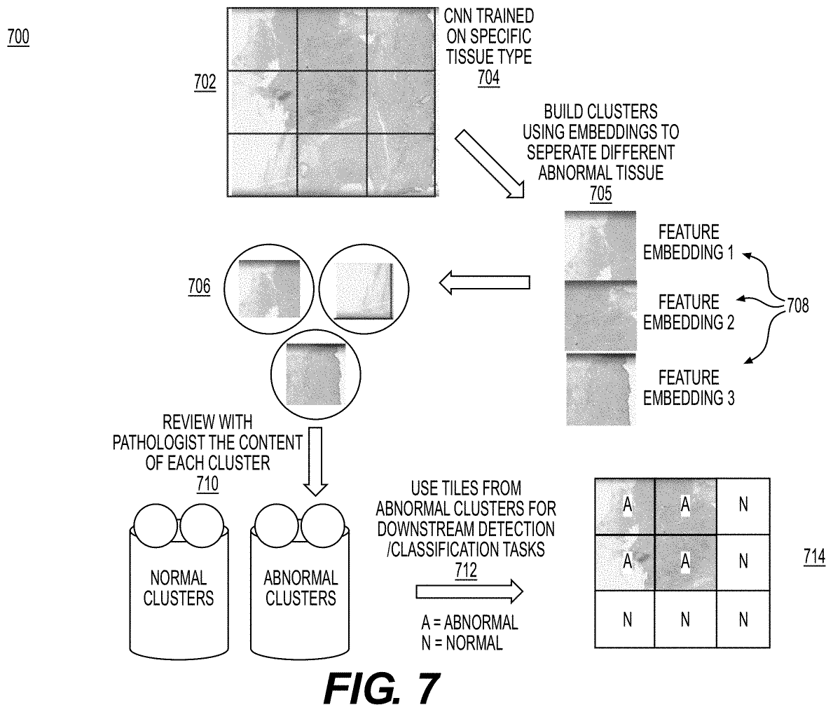

FIG. 1A illustrates a block diagram of a system and network for processing electronic images to identify morphologies, according to an exemplary aspect of the present disclosure. Specifically, FIG. 1A illustrates an electronic network 120 that may be connected to servers at hospitals, laboratories, and/or doctors' offices, etc. For example, physician servers 121, hospital servers 122, clinical trial servers 123, research lab servers 124, and/or laboratory information systems (LIS) 125, etc., may each be connected to electronic network 120, such as the Internet, through one or more computers, servers, and/or handheld mobile devices. According to an exemplary aspect of the present disclosure, electronic network 120 may also be connected to server systems 110, which may include processing devices 100 that are configured to implement a tissue characterization platform 101 configured to process images to generate a plurality of foreground tiles. Server systems 110 may also include image analysis tool 102, as described below, which may be configured to use one or more machine learning systems to classify foreground tiles and/or cluster the foreground tiles based on one or more extracted vector of features.

Physician servers 121, hospital servers 122, clinical trial servers 123, research lab servers 124, and/or LIS 125 may create or otherwise obtain medical images of varying modalities. For example, digital medical images, including one or more patients' whole slide image(s), cytology specimen(s), histopathology specimen(s), slide(s) of the cytology specimen(s), digitized images of the slide(s) of the histopathology specimen(s), or any combination thereof, may be created or obtained. Additionally or alternatively, images of other modality types, including magnetic resonance imaging (MRI), computed tomography (CT), X-ray, nuclear medicine imaging, or ultrasound, may be created or obtained. Physician servers 121, hospital servers 122, clinical trial servers 123, research lab servers 124, and/or LIS 125 may also obtain any combination of patient-specific information, such as age, medical history, cancer treatment history, family history, past biopsy or cytology information, etc. Server systems 110, physician servers 121, hospital servers 122, clinical trial servers 123, research lab servers 124, and/or LIS 125 may transmit medical images and/or patient-specific information to server systems 110 over electronic network 120 in a digital or electronic format.

Physician servers 121, hospital servers 122, clinical trial servers 123, research lab servers 124, and/or LIS 125 refer to systems used for viewing medical images of varying modalities, including digital whole slide images. Medical images may be utilized by both medical professionals (e.g., pathologists, physicians, etc.) and AI systems alike for training purposes to improve accuracy in detecting morphologies, among other tasks. A greater availability of image data presenting a particular morphology enhances both medical professionals and AI systems ability to learn given the increased variability in the presentation among the image data. However, rare conditions or diseases often do not have large amounts of associated image data, which necessarily limits the morphology data that can be learned. For example, determination of a rare morphology may be made difficult due to low levels of diagnosis and resultant low amounts of data collected from patients that may have the rare morphology (e.g., if a physician is unfamiliar with a particular rare disease, they may not collect the requisite data to analyze the morphology).

At least a portion of the medical images may include training images that are used for training AI systems and/or medical professionals to diagnose conditions or predict morphologies. In some examples, some of the training images may be withheld and used as testing images to evaluate an accuracy of a diagnostic system. Some of the medical images may present conditions (e.g., within one or more foreground tiles with unknown morphology), while others of the medical images may include reference images that do not include or present conditions and/or clusters (e.g., within one or more foreground tiles is adipose tissue). The medical images stored for use as training images may be stored in association with labels indicating data types of the medical images, including any morphologies present, for use in training. These labels may be sourced from the LIS 125. Server systems 110 may also include processing devices for processing images and data stored in storage devices 109.

Server systems 110 may include one or more storage devices 109 for storing data, e.g., digital whole slide images and data received from at least one of the processing devices 100, physician servers 121, hospital servers 122, clinical trial servers 123, research lab servers 124, and/or LIS 125. In some examples, storage devices 109 may include one or more data stores for storing the data, e.g., cloud-based storage, hard disk, and/or random-access memory (RAM). As discussed below, storage devices 109 may store one or more trained machine learning systems, machine learning system outputs, etc. For example, the cluster assignments for the plurality of foreground tiles, generated by image analysis tool 102, may be stored within storage devices 109.

Server systems 110 may include one or more machine learning tool(s) or capabilities. For example, processing devices 100 may execute one or more machine learning systems utilized by image analysis tool 102, according to one aspect. In some techniques, tissue characterization platform 101 may include image analysis tool 102. Alternatively or in addition, the present disclosure (or portions of the system and methods of the present disclosure) may be performed on a local processing device (e.g., a laptop).

According to an exemplary aspect of the present disclosure, tissue characterization platform 101 may be implemented to generate a plurality of foreground tiles within digital medical images. This implementation may also normalize magnification across the plurality of foreground tiles. FIG. 1B illustrates an exemplary block diagram of the tissue characterization platform 101. The tissue characterization platform 101 may include an image analysis tool 102, a data ingestion tool 103, a tile determination tool 104, and a viewing application tool 108.

Image analysis tool 102, described in more detail below, refers to a process and system for identifying and predicting one or more attributes of whole slide images. Machine learning may be used to predict clinical outcomes, e.g., survival rate, based on one or more morphologies, e.g., new or unknown morphologies, present in a whole slide image. Machine learning may be further used to determine tissue-specific morphologies present within a digital whole slide image, according to an exemplary technique. Image analysis tool 102 may also be used for clustering one or more foreground tiles based on an abnormality score to streamline tissue analysis, according to another exemplary technique.

The data ingestion tool 103 may facilitate a transfer of the digital whole slide images to the various tools, modules, components, and devices that are used for processing the whole slide images, according to an exemplary aspect. In some examples, if the digital whole slide image is adjusted utilizing one or more features of the tissue characterization platform 101, e.g., image magnifier 105, only the adjusted digital whole slide image may be transferred. In other examples, both the original digital whole slide image and the adjusted digital whole slide image may be transferred. Data ingestion tool 103 may convert the digital whole slide images into one or more preferred formats, e.g., JPG or JPEG2000.

Digital whole slide images, e.g., those transferred by data ingestion tool 103, may be received by tile determination tool 104. Tile determination tool 104 may comprise an image magnifier 105 and a foreground module 106. The images may be analyzed using image magnifier 105, which may specify a magnification level for extraction of the foreground tiles. For example, the plurality of digital whole slide images may be normalized to a given magnification via image magnifier 105.

Foreground module 106 may generate a plurality of foreground tiles within each digital whole slide image. Foreground module 106 may generate a plurality of foreground tiles (e.g., regions in the digital whole slide image with tissue) and/or background tiles (e.g., regions in the digital whole slide image without tissue or with artifacts) using one or more methods described herein. Foreground module 106 may use an artifact detector system to detect tiles with artifacts, e.g., tiles that contain blur, thick sections, noise, etc. Background tiles, along with tiles determined to contain artifacts, may be removed from the digital whole slide image or marked as irrelevant for later processors. Foreground tiles may be any suitable shape, e.g., square, and may be stored, e.g., in storage devices 109.

The tissue characterization platform 101 may also provide graphical user interface (GUI) control elements (e.g., slider bars) for display in conjunction with the whole slide image through a user interface of the viewing application tool 108. Viewing application tool 108 may allow user-input based annotation of slides for tissue type, known-unknown classification, and normal-abnormal classification, among other similar examples, as described in greater detail below.

The viewing application tool 108 may also provide a user (e.g., pathologist) a user interface that displays the digital whole slide images throughout various stages of adjustment. For example, viewing application tool 108 may display digital whole slide images that have not been processed by data ingestion tool 103 and/or foreground tiles output from viewing application tool 108. The user interface may also include the GUI control elements of the image analysis tool 102 that may be interacted with to annotate the whole slide images and/or the foreground tiles, according to an exemplary technique. The information may be provided through various output interfaces (e.g., a screen, a monitor, a storage device and/or a web browser, etc.).

FIG. 10 illustrates a block diagram of image analysis tool 102, according to an exemplary technique. The image analysis tool 102 may include a training image platform 131 and/or a target image platform 135. This implementation may increase an amount of medical image data associated with a rare presentation, e.g., of a rare cancer, that is available for training of machine learning systems and/or medical professionals.

According to one technique, the training image platform 131 may include a plurality of software modules, such as a training data intake module 132, a training classifier module 133, and a training clustering module 134. Training image platform 131, according to one aspect, may be configured to create or receive training images that are used to train one or more machine learning systems for identifying unknown and/or abnormal morphologies. Exemplary machine learning systems are discussed in detail below. In some examples, the medical images may be a direct output of one or more of the machine learning systems. In other examples, the output of one or more of the machine learning systems may be used as input to further processes that enable identification of unknown and/or abnormal morphologies. The training images may be received from any one or any combination of server systems 110, physician servers 121, hospital servers 122, clinical trial servers 123, research lab servers 124, and/or LIS 125. Images used for training may come from real sources (e.g., humans, animals, etc.) or may come from synthetic sources (e.g., graphics simulators, graphics rendering engines, 3D models, etc.). In other examples, a third party may train one or more of the machine learning systems and provide the trained machine learning system(s) to server systems 110 for storage (e.g., in storage devices 109) and/or execution by image analysis tool 102.

Training data intake module 132 may create or receive the one or more datasets, including training images, known morphologies and/or patterns, normal and/or abnormal morphologies and/or patterns, clinical data, tile or slide annotations, etc. Training images may include digital whole slide images, such as digitized histology or cytology slides stained with a variety of stains, including, but not limited to, Hematoxylin and eosin, hematoxylin alone, toluidine blue, alcian blue, Giemsa, trichrome, acid-fast, Nissl stain, etc. The training images may be divided into one or more foreground tiles, e.g., by tissue characterization platform 101. Known morphologies may include various forms of cancer, normal tissue, etc. Clinical data may include overall survival data, progression-free survival with corresponding censored data, drug treatment outcome data, etc. Tile or slide annotations may include determinations by a medical professional, e.g., a pathologist, about morphological patterns displayed in a slide. For example, a pathologist may review one or more foreground tiles to determine whether the tiles contain unknown or abnormal morphologies and/or patterns, these determinations being annotated on the tile. In some examples, a subset of training datasets may overlap between or among the various training images, known morphologies and/or patterns, clinical data, and/or tile or slide annotations. The datasets may be stored on a digital storage device (e.g., one of storages devices 109).

Training classifier module 133 may generate, using at least the datasets corresponding to WSIs and known tissue types as input, one or more machine learning systems capable of predicting a classification for the plurality of foreground tiles, e.g., known or unknown morphologies and/or normal or abnormal morphologies. Training classifier module 133 may be configured to receive one or more training datasets, including, but not limited to, WSIs, known morphologies, normal morphologies, tile and/or slide annotations, etc. Training classifier module 133 may receive training datasets from training data intake module 132, tissue characterization platform 101, storage devices 109, etc. As discussed in more detail below, training classifier module 133 may use supervised, semi-supervised, or unsupervised training to generate a machine learning system configured to analyze training datasets. For example, training classifier module 133 may include an open-set classifier (e.g., open-set regularization methods), such as, but not limited to, Tempered Mixup, Open Data Inventory (ODIN), and/or One-Class Support Vector Machine (SVM), etc. Training classifier module 133 may be configured to output a trained classifier and/or one or more outputs. The trained classifier may be stored in one or more storage systems, e.g., a storage system internal to training image platform 131 or in storage devices 109.

Training clustering module 134 may generate, using at least the datasets corresponding to known and/or unknown vectors of features as input, one or more trained machine learning systems (e.g., a clustering algorithm) capable of extracting a vector of features from foreground tiles and clustering the foreground tiles, e.g., based on the extracted vectors. As discussed in more detail below, training clustering module 134 may use supervised, semi-supervised, or unsupervised training to generate a machine learning system configured to analyze training datasets. For example, training clustering module 134 may include a clustering algorithm, such as, but not limited to a Mixture Model, K-Means, agglomerative clustering, etc. In some examples, a clustering algorithm may be generated for each of the different tissue types to learn a corresponding unknown classification. For example, a clustering algorithm may be trained for large intestinal tissue morphologies and another clustering algorithm may be trained for prostate tissue morphologies. In other examples, one clustering algorithm may be generated that is capable of learning unknown classifications for more than one tissue type. The trained clustering algorithm may be stored in one or more storage systems, e.g., a storage system internal to training image platform 131 or in storage devices 109.

According to one technique, the target image platform 135 may include software modules, such as a target data intake module 136, a classifier module 137, a clustering module 138, and an output interface 140. Target image platform 135 may receive a target dataset at target data intake module 136. Target datasets may include, e.g., digital WSIs, foreground tiles, known morphology annotations, etc. Target datasets may be received from any one or any combination of the server systems 110, physician servers 121, hospital servers 122, clinical trial servers 123, research lab servers 124, and/or LIS 125.

Classifier module 137 may receive a trained classifier, e.g., from training classifier module 133 or storage devices 109, and/or target datasets from other aspects of environment 100c, 100b, and/or 100a, such as from storage devices 109 and/or from target data intake module 136. As discussed herein, classifier module 137 may include an open-set classifier (e.g., open-set regularization methods), such as, but not limited to, Tempered Mixup, Open Data Inventory (ODIN), and/or One-Class Support Vector Machine (SVM), etc. Classifier module 137 may be configured to output foreground tiles classified into a known category (e.g., various known forms of cancer, normal tissue, etc.) and/or an unknown category (e.g., unrecognized and atypical patterns). Classifier module 137 may add foreground tiles with an “unknown” classification (unknown foreground tiles) to a database, e.g., storage devices 109, of other foreground tiles with an “unknown” classification. Classifier module 137 may discard or store foreground tiles with a “known” classification (known foreground tiles) to a database, e.g., storage devices 109.

Clustering module 138 may receive a trained clustering algorithm, e.g., from training cluster module 134 or storage device 109, and/or target datasets from other aspects of environment 100c, 100b, and/or 100a, such as from storage devices 109 and/or from classifier module 137. As discussed herein, the trained clustering algorithm may include, e.g., a Mixture Model, K-Means, agglomerative clustering, etc. Clustering module 138 may be configured to receive as input classified foreground tiles, e.g., unknown foreground tiles. Clustering module 138 may be configured to extract one or more vector of features from the one or more unknown foreground tiles and/or to cluster one or more foreground tiles based on the one or more extracted vector of features. The vector of features may encode the information within a tile, e.g., a tile containing one or more morphologies, and/or describe tiles, e.g., to map the tiles to canonical morphological patterns. Clustering module 138 may be configured to output foreground tiles clustered based on the extracted vector of features. Clustering module 138 may also be configure to correlate outcome based on clusters, as described in more detail below. The outputted cluster assignments may be annotated on the respective foreground tile and/or stored in a database, e.g., storage devices 109.

The output interface 140 may be used to output the foreground tile clusters (e.g., to a screen, monitor, storage device, web browser, etc.). A user, e.g., a pathologist, may interact with output interface 140 to annotate the foreground tiles, e.g., to determine normal and abnormal regions.

Target image platform 135, according to one aspect, may receive a request for identification of one or more unknown features and execute one or more of the machine learning systems trained by training image platform 131 to generate one or more clusters of medical images with unknown morphologies. For example, the request may be received from any one or any combination of the server systems 110, physician servers 121, hospital servers 122, clinical trial servers 123, research lab servers 124, and/or LIS 125. In another example, the request may be automatically be generated by image analysis tool 102 in response to detecting a number of medical images stored in storage devices 109 (e.g., a number of medical images determined to have unknown morphologies).

FIG. 2 depicts a flow chart of an exemplary method for processing electronic images to identify unknown or rare morphologies, according to one or more techniques. This implementation may analyze digital WSIs to detect unknown or rare morphologies and/or predict outcomes. At step 202, one or more digital whole slide images associated with a patient may be received, e.g., at tissue characterization platform 101. At step 204, a plurality of foreground tiles may be determined within the one or more digital WSIs associated with a patient, e.g., by foreground module 106. The one or more foreground tiles may be determined by any suitable means, e.g., by using thresholding based on the variance of the pixels and/or voxels in a tile, by using Otsu's method, thresholding based on minimizing intra-class intensity variance, thresholding based on maximizing inter-class intensity variance, and/or by comparing the tile pixel and/or voxel values to a reference foreground distribution.

At step 206, one or more foreground tiles may be classified, e.g., by classifier module 137, based on known morphologies and unknown morphologies. Classifier module 137 may classify the foreground tiles by open-set regularization methods (e.g., Tempered Mixup, Open Data Inventory (ODIN), and/or One-Class Support Vector Machine (SVM)), by supervised learning methods (e.g., CNN-based methods or logistic regression), and/or by any other suitable means. Training classifier module 137 is described in more detail below. Classifier module 133 may annotate which foreground tiles contain known morphologies or patterns and which foreground tiles contain unknown morphologies or patterns. In some techniques, the foreground tiles may be labeled based on known patterns within the annotated known pattern category. For example, foreground tiles with known morphologies may be annotated with the known morphology. In some techniques, digital WSI tiles with artifacts and/or irrelevant tissue regions may be discarded by the trained machine learning system, e.g., using an artifact detector system or hand-annotation. Artifacts may include blur, thick sections, etc., and irrelevant tissue regions may include fat, background, etc.

At step 208, the unknown foreground tiles may be provided to a clustering algorithm, e.g., clustering module 138. The one or more unknown foreground tiles may be clustered based on at least one vector of features. As described herein, the at least one vector of features may be extracted by any suitable means, e.g., by clustering module 138, including hand-engineered features, pre-trained CNN embeddings using supervised learning, pre-trained CNN embeddings using self-supervised learning techniques, and/or pre-trained transformer neural network features. Hand-engineered features may include, e.g., Scale-Invariant Feature Transform (SIFT), Oriented FAST and Rotated BRIEF (ORB), Rapid parameter Inference on gravitational wave sources via Iterative FiTting (RIFT), and/or speed Up Robust Features (SURF). Clustering may be conducted using any suitable method, e.g., Mixture Model, K-Means clustering, agglomerative clustering, and/or Expectation-Maximization Algorithm clustering.

At step 210, one or more outcomes may be predicted based on the unknown foreground tile clusters. For example, predicted outcomes may include, but are not limited to, overall survival data, progression-free survival with corresponding censored data, drug treatment outcome data, data related to relapse, presence or severity of disease, treatment success rate, etc. The system may determine that certain unknown patterns are strongly correlated with certain patient metadata (e.g., may determine that certain unknown patterns are correlated with relapse of cancer). In other words, certain techniques may link the clusters of unknown morphological patterns to clinical outcomes. This may improve an accuracy of detection, classification, or treatment for diseases. In some techniques, the clustered foreground tiles and/or the outcomes may be outputted, e.g., to a GUI.

In certain techniques, the system may then process slide images for actual tissue samples (e.g., from a laboratory). The system may then output information or a score based on the processing. For example, the information or score may confirm or contradict another morphological pattern analysis (e.g., a Gleason score), may indicate an accuracy of a diagnosis or a severity of a disease, a likelihood of success of treatment or a likelihood of relapse, and/or the like based on the correlations between the unknown patterns and patient data. In this way, certain techniques described herein may identify rare morphologies without explicitly having information about whether they exist beforehand. In addition, certain techniques may correlate rare morphologies to outcome data. Further, certain techniques may facilitate use of unknown morphology tissue regions for other clinical-related tasks.

FIG. 3 depicts a flow chart of an exemplary method for training one or more machine learning systems of FIG. 2. At step 302, one or more digital whole slide images associated with a patient may be received, e.g., from LIS 125. At step 304, known morphology data corresponding to the one or more digital whole slide images associated with a patient may be received. Known morphology data may include recorded morphologies of various forms of cancer, normal tissue, etc. At step 306, a magnification level may be determined for each of the one or more digital WSIs and the magnification level may be normalized, e.g., by image magnifier 105.

At step 308, a plurality of foreground tiles within the one or more digital WSIs associated with a patient may be determined. As discussed herein, the digital WSIs may be divided, e.g., into square tiles, based on the foreground and background of the slide. The foreground tiles may be determined by thresholding based on the variance of the pixels in a tile to identify if they are foreground, using Otsu's method, comparing the tile pixel values to a reference foreground distribution etc. Foreground tiles may be isolated for further analysis or stored (e.g., in storage devices 109). Background tiles and/or other irrelevant tiles, e.g., tiles with artifacts, may be discarded.

At step 310, a machine learning system may be trained to determine whether each foreground tile of the plurality of foreground tiles contains a known morphology or an unknown morphology. In some techniques, the model may be trained using supervised or semi-supervised training, but any suitable approach to training the model may be used. The model may be trained using foreground tiles annotated based on known morphologies present in a foreground tile and/or that have been filtered to remove tiles with artifacts and/or irrelevant tissue regions, as described herein.

In some examples, the supervised machine learning system may be trained using strong annotations (e.g. digital WSIs labeled with known morphologies). In such examples, the supervised machine learning system may include a multi-modal deep neural network, graph neural networks, transformer neural networks, convolutional neural network (CNN), a multi-layer perceptron (MLP), a support vector machine (SVM), a nearest neighbor algorithm model, or a random forest algorithm model, among other similar examples. To enable learning, one or more digital WSIs, a plurality of foreground tiles, and/or known morphologies associated with the digital WSIs and/or foreground tiles, may be provided as input to the machine learning system. One or more vector of features may be extracted from each foreground tile, which may be performed using a range of techniques, e.g., hand-engineered features (e.g., scale-invariant feature transform (SIFT), oriented fast and rotated brief (ORB), radiation-invariant feature transform (RIFT), speeded up robust features (SURF), etc. descriptors), pre-trained convolutional neural network (CNN) embeddings using supervised learning, pre-trained CNN embeddings using self-supervised learning techniques, pre-trained transformer neural network features, etc.

The machine learning system may output foreground tiles with predicted known morphologies and predicted unknown morphologies. The predicted unknown morphologies may be compared to corresponding annotated known and/or unknown morphologies to determine a loss or error. The corresponding known morphologies may be a portion of a strong annotation of the training gene sequencing data that corresponds to a foreground tile and indicates known cancerous tissue morphologies within the foreground tiles. The machine learning system may be modified or altered (e.g., weights and/or bias associated with one or more nodes and/or layers may be adjusted) based on the error to improve an accuracy of the machine learning system. This process may be repeated for each of the training digital WSIs received or at least until a determined loss or error is below a predefined threshold. In some examples, a portion of the training digital WSIs may be withheld and used to further validate or test the machine learning system.

In other examples, the supervised machine learning system may be trained using Multiple Instance Learning (MIL) and weak annotations (e.g., labels at a tile- or region-level). For example, when MIL is used, the machine learning system receives a set of “bags”, each including a plurality of “instances”. Specifically, each of the training foreground tiles may be described as a “bag” and extracted vector of features from respective training foreground tiles may be the “instances” included in the “bag”. A weak annotation may be associated with the “bag”. For example, training foreground tiles may be labeled as positive for an unknown morphology if at least one of the vector of features included in the training foreground tile is indicative of the given unknown morphology. To learn, the machine learning system may identify the at least one vector of features that is common across training foreground tiles labeled as positive for the unknown morphology. Once trained, the machine learning model may be configured to generate a respective output of one or more foreground tiles classified based on at least one unknown morphology.

At step 312, upon determining that one or more foreground tiles contain an unknown morphology, a clustering algorithm may be trained to cluster a plurality of vector of features associated with one or more unknown foreground tiles. Any suitable approach to training the model may be used, e.g., unsupervised learning. Unsupervised learning may be configured to learn to group similar vector of features associated with foreground tiles together without the use of target labels. Vector of features may be treated as instances, and the number of groupings may either be pre-specified or learned automatically by the algorithm. Such clustering algorithms may include, but are not limited to Tempered Mixup, ODIN, OpenMax, One-class SVM, expectation maximization (EM), majorization maximization (MM), K-nearest neighbor (KNN), hierarchical clustering, and/or agglomerative clustering. The resulting trained clustering algorithm may be used by clustering module 138 to cluster foreground tiles based on extracted vector of features.

As discussed herein, patient outcomes may be directly predicted from digital WSIs. In some aspects, patient outcomes may be predicted from unknown morphologies using a binary model, such as depicted in FIG. 4. This may circumvent pre-existing tests that may try to predict outcome solely from known morphologies, e.g., Gleason patterns, cribriform patterns, well-differentiated patterns, etc. Environment 400 of FIG. 4 depicts an exemplary schematic for determining a correlation between the presence of one or more unknown morphologies in at least one foreground tile and outcome data for each unknown morphology.

One or more foreground tiles 402 (derived from one or more digital whole slide images using one or more methods described herein) may be inputted to open set classifier 401. Open set classification may provide a classifier, e.g., classifier module 137 and/or open set classifier 401, with the ability to classify data that do not fit within another classification into an unknown classification. In aspects where many similar-looking rare morphologies of a specific tissue type are determined, open set classifier 401 may be configured to determine a correlation between the rare morphologies and patient outcomes, e.g., 5-year survival rate. The open set classifier 401 may determine tissue regions predicted to have unknown patterns (step 403).

The one or more known foreground tiles 404 may be discarded or stored, e.g., in storage devices 109. The one or more unknown foreground tiles 405 may be stored, e.g., in storage devices 109, and/or clustered into one or more clusters 406 based on one or more vectors of features (step 407). The one or more vector of features may be extracted by one or more methods described herein, e.g., by hand-engineered features and/or by pre-trained CNN embeddings. The one or more clusters of unknown foreground tiles 405 may be used to predict outcomes based on the similarities between the one or more clusters of unknown foreground tiles 405 (step 408).

In some techniques, a machine learning system 409, e.g., a binary model CNN, may be configured to predict outcomes from the one or more clusters of similar unknown morphologies, determined in step 408. Outcomes of patients that have patterns assigned may be correlated to each cluster to determine if any patterns occur, which may indicate that the patterns may be associated with better or worse outcomes as compared to known morphologies. Machine learning system 409 may be trained using any method described herein, e.g., semi-supervised training.

Methods for identifying morphologies in digital WSIs may include techniques in addition to those described above. In some techniques, it may be beneficial to classify and/or cluster the foreground tiles based on normal and abnormal morphologies. These techniques may further improve the quality and speed of the analysis of vast amounts of foreground tiles. The figures and schematics below describe some aspects of these exemplary techniques.

FIG. 5 depicts a flow chart of a method for using clustering methods coupled with pathologist annotation and active learning, according to one or more techniques. At step 502, one or more digital WSIs associated with a patient may be received. At step 504, a plurality of foreground tiles may be determined within the one or more digital whole slide images associated with a patient, as discussed herein. For example, the foreground tiles may be determined using Otsu's method.

At step 506, whether each foreground tile of the plurality of foreground tiles contains a normal morphology or an abnormal morphology may be determined using a trained machine learning model. The machine learning model may be trained using methods described in more detail below. The trained machine learning model may include hand-engineered features (e.g., SIFT, ORB, RIFT, SURF, etc. Descriptors), pre-trained CNN embeddings using supervised learning, pre-trained CNN embeddings using self-supervised learning techniques, pre-trained transformer neural network features, etc., as described herein. The trained machine learning model may be configured to extract at least one vector of features from the one or more foreground tiles and, based on the at least one vector of features, predict whether the foreground tiles contain a normal morphology (normal foreground tile) or the foreground tiles contain an abnormal morphology (abnormal foreground tile). Normal foreground tiles may be discarded or stored, e.g., in storage devices 109. Abnormal foreground tiles may be stored or further analyzed.

At step 508, upon determining one or more abnormal foreground tiles, the one or more abnormal foreground tiles may be provided to a clustering algorithm. The clustering algorithm may be trained using methods described in more detail below. The clustering algorithm may include any suitable algorithm, e.g., Mixture Model, a K-Means, an EM algorithm approach, etc. The clustering algorithm may cluster one or more abnormal foreground tiles based on one or more vector of features extracted from the abnormal foreground tiles.

Based on the abnormal morphology cluster and/or the vector of features, at least one outcome may be predicted at step 510. Outcomes, as discussed herein, may include patient prognosis, years of survival, likelihood of response to medication, likelihood of recurrence, likelihood of metastasis, survival rate, effective medication type, effective treatment type, 5-year survival rate, etc. The one or more predict outcomes may be outputted to a GUI, e.g., output interface 140.

FIG. 6 depicts a flow chart of an exemplary method for training the one or more machine learning systems of FIG. 5, according to some techniques. At step 602, one or more digital whole slide images associated with a patient may be received. At step 604, normal morphology data and abnormal morphology data, each corresponding to the one or more digital WSIs associated with a patient, may be received. Normal morphology data may include patterns that are common across data points, e.g., common across a population of digital whole slide images.

At step 606, a plurality of foreground tiles within the one or more digital WSIs associated with a patient may be determined. As discussed herein, a magnification level may be determined and normalized for each of the one or more digital WSIs, e.g., by image magnifier 105. The digital WSIs may be divided, as discussed herein, based on the foreground and background of the slide. The foreground tiles may be determined using methods described herein, e.g., by comparing the tile pixel values to a reference foreground distribution. Foreground tiles may be isolated for further analysis or stored (e.g., in storage devices 109), and background tiles and/or other irrelevant tiles, e.g., tiles containing artifacts, may be discarded.

At step 608, a clustering algorithm may be trained to cluster a plurality of vector of features associated with one or more normal foreground tiles and/or one or more abnormal foreground tiles. Any suitable approach to training the model may be used, e.g., unsupervised clustering. Unsupervised clustering may learn to group similar vector of features associated with foreground tiles together without the use of target labels. Vector of features may be treated as instances, and the number of groupings may either be pre-specified or learned automatically by the algorithm. Such clustering algorithms may include, but are not limited to Tempered Mixup, ODIN, OpenMax, One-class SVM, expectation maximization (EM), majorization maximization (MM), K-nearest neighbor (KNN), hierarchical clustering, and/or agglomerative clustering. The resulting trained clustering algorithm may be used by clustering module 138 to cluster foreground tiles based on extracted vector of features into one or more clusters based on normal morphologies or abnormal morphologies.

At step 610, a medical professional may review the outputted clusters. In some techniques, foreground tiles clusters be visualized so that the tiles can be analyzed, e.g., by a pathologist. Using their training, the pathologist may use their subjective understanding of normal morphologies and abnormal morphologies to review the clusters output by the clustering algorithm, e.g., whether one or more abnormal clusters contain non-rare cancer information. The pathologist may annotate the contents of the cluster and feed that data into the clustering algorithm. Based on the pathologist's input, the clustering algorithm may adjust its labeling. Pathologist review may be conducting during training as well as during use of the trained machine learning system.

At step 612, a machine learning system may be trained to determine whether each foreground tile within a cluster of foreground tiles contains a normal morphology or an abnormal morphology. In some techniques, the machine learning system may be trained using supervised training methods, as discussed herein, but any suitable approach to training the system may be used. The machine learning system may be trained using foreground tiles that have been clustered based on one or more vector of features, and/or using pathologist annotations, as described herein. The clusters outputted at step 610 may be inputted to the machine learning system as labels, e.g., of normal or abnormal morphologies.

In some examples, the supervised machine learning system may be trained using strong annotations (e.g. clustered foreground tiles annotated by a pathologist). In such examples, the supervised machine learning system may include a multi-modal deep neural network, logistic regression, transformer neural networks, convolutional neural network (CNN), a multi-layer perceptron (MLP), a support vector machine (SVM), a nearest neighbor algorithm model, or a random forest algorithm model, among other similar examples. To enable learning, one or more digital WSIs, a plurality of foreground tiles, one or more clusters of foreground tiles, and/or normal morphologies associated with the digital WSIs, foreground tiles, and/or clusters, may be provided as input to the machine learning system. The machine learning system may then output predicted abnormal morphologies within the foreground tiles and/or within one or more clusters. The predicted abnormal morphologies may be compared to corresponding annotated normal and/or abnormal morphologies to determine a loss or error. The corresponding normal morphologies may be a portion of a strong annotation of the training clusters that corresponds to a foreground tile and indicates normal tissue aspects of the foreground tiles. The machine learning system may be modified or altered (e.g., weights and/or bias associated with one or more nodes and/or layers may be adjusted) based on the error to improve an accuracy of the system. This process may be repeated for each of the training clusters received or at least until a determined loss or error is below a predefined threshold. In some examples, a portion of the training clusters may be withheld and used to further validate or test the machine learning system.

In other examples, the supervised machine learning system may be trained using Multiple Instance Learning (MIL) and weak annotations (e.g., labels at a tile- or region-level). For example, when MIL is used, the machine learning system receives a set of “bags”, each including a plurality of “instances”. Specifically, each of the training foreground tiles may be described as a “bag” and extracted vector of features from respective training foreground tiles may be the “instances” included in the “bag”. A weak annotation may be associated with the “bag”. For example, training clusters may be labeled as positive for an abnormal morphology if at least one of the vector of features included in the training foreground tile is indicative of the given abnormal morphology. To learn, the machine learning system may identify the at least one vector of features that is common across training foreground tiles labeled as positive for the abnormal morphology. Once trained, the machine learning model may be configured to generate a respective output of one or more foreground tiles classified based on at least one abnormal morphology. Steps 608, 610, and 612 may be repeated as needed to increase accuracy of the clustering algorithm, e.g., to reduce errors to below a certain threshold.

In some aspects, the amount of data, e.g., digital WSIs, to be analyzed by one or more systems can make the analysis process labor intensive and slow. For example, a single digital WSI can contain thousands of foreground tiles, each tile to be annotated by a pathologist. In this example, annotation may take an exorbitant amount of time, thereby delaying training and compromising the output data. However, if the foreground tiles are first clustered based on predicted abnormality, as described in FIGS. 5 and 6, faster training time and better outputs may result. FIG. 7 depicts an exemplary schematic of this process.

As depicted in environment 700 of FIG. 7, one or more foreground tiles 702 (derived from one or more digital WSIs by methods described herein) may be inputted to a CNN trained on a specific tissue type (tissue-specific CNN) 704. Tissue-specific CNN 704 may extract one or more embeddings 708, e.g., tissue-specific features, from the foreground tiles. The one or more embeddings 708 may be used to assign each foreground tile to a cluster (step 705). Each cluster may be an interpretation of an abnormality of a given region. The one or more clusters 706 may be reviewed by a medical professional (step 710), e.g., a pathologist. Pathologist review may be conducted to evaluate the accuracy of the clusters. For example, the training data may not include labels for all normal and/or abnormal morphological patterns, and the pathologist may input information to the system that one or more of the normal and/or abnormal morphology patterns are actually normal and/or abnormal morphological patterns. At step 712, the tiles from the abnormal clusters may be used for downstream detection or classification tasks, e.g., for predicting tissue-specific, rare morphologies. In some techniques, a digital whole slide image with the normal foreground tiles removed or annotated on the tiles 714 may be outputted. Some techniques may use the cluster assignments as labels for training a supervised model and the process may be repeated.

For label generation, e.g., cluster labels, it may be difficult and time consuming to generate labels for training a model for a specific tissue type since many reports from many sites may need to be reviewed with pathologists in order to understand what features need to be identified and for standardizing the data. In some cases, the reports themselves may not include all the information that is present in the slide or there may be different opinions. This may result in there being a need for several iterations to build a sufficient system. A system that may detect abnormal tissue with limited supervision may facilitate faster iteration without label selection or label generation, which may facilitate quicker turnaround for downstream biomarker tasks.

An exemplary schematic for using cluster labels to train a classifier when label logic is limited is depicted in FIG. 8. As depicted in environment 800, one or more foreground tiles 802 (derived from one or more digital WSIs by methods described herein) may be inputted to a CNN, e.g., a self-supervised CNN 804. Self-supervised CNN 804 may extract one or more embeddings 808 from the foreground tiles, which may be used to separate different abnormal tissues into clusters (step 806). The one or more clusters 811 may be reviewed by a medical professional (step 812) e.g., a pathologist. Pathologist review may be conducted to confirm the abnormal and normal regions and/or morphologies. At step 813, the tiles from the abnormal clusters may be used for downstream detection or classification tasks, e.g., for predicting tissue-specific, rare morphologies. In some techniques, an algorithm may be used to remove or exclude the normal foreground tiles (see 814). At step 816, a semi-supervised or fully-supervised CNN may be trained to predict regions of interest for different tissue types. The predicted regions of interest, outputted from the tissue-specific CNN 818, may be filtered for downstream H&E-based biomarker tasks (step 820). Tissue-specific CNN 818 may be trained using any suitable method.

In some techniques, the tissue type may be provided to the system as a strong annotation, which may increase accuracy and sensitivity to detecting morphologies of a given tissue type. FIG. 9 depicts a flow chart of an exemplary method for using unsupervised learning with strong annotations, according to one or more techniques. At step 902, one or more whole slide images associated with a patient may be received. In some techniques, the tissue type that was indicated in the Lab Information system or other database may also be received. At step 904, a plurality of foreground tiles within the one or more digital WSIs associated with a patient may be determined, using any suitable method as discussed herein.

At step 906, a trained machine learning system may determine whether each foreground tile of the plurality of foreground tiles contains a normal morphology or an abnormal morphology based on a binarized abnormality score. The presence of normal and/or abnormal morphologies may be determined based on tensor or vector of features. One or more tensor or vector of features may be extracted using one or more techniques described herein, e.g., hand-engineered features, pre-trained CNN embeddings using supervised learning, pre-trained CNN embeddings using self-supervised learning techniques, pre-trained transformer neural network features, the original unaltered pixel patch, etc. The trained machine learning system, e.g., classifier module 137, may be trained using techniques described in FIG. 10. The trained classifier may output an abnormality score based on a binarized abnormality threshold. In some aspects, the trained classifier and/or the binarized outputs from the trained classifier may be stored, e.g., in storage devices 109. In some techniques, the abnormality score may be used to filter foreground tiles for downstream tasks, e.g., screening rare cancer morphologies.

FIG. 10 depicts a flow chart of an exemplary method for training the machine learning system described in FIG. 9. At step 1002, one or more digital WSIs associated with a patient may be received. The one or more digital WSIs may be annotated, e.g., specified using polygons, pixel masks, etc., based on the kind of tissues present on locations of the slide. At step 1004, normal morphology data and abnormal morphology data corresponding to one or more foreground tiles within one or more digital WSIs may be received. At step 1006, a plurality of foreground tiles with the one or more digital WSIs associated with a patient may be determined. The plurality of foreground tiles may be determined based on the annotations from step 1002. As described herein, any suitable method may be used to determine foreground tiles, such as, but not limited to, thresholding based on the variance of the pixels in a tile to identify if they are foreground.

At step 1008, the machine learning system may be trained to determine whether each foreground tile contains a normal morphology or an abnormal morphology based on a binarized abnormality score. The binarized abnormality score may be determined by classifying, e.g., using a classifier (such as classifier module 137), tensor or vector of features extracted from the foreground tiles. The classifier may be trained using supervised learning to determine an abnormality score threshold based on the tensor or vector of features. The abnormality score threshold may be used to determine if an abnormality score may be truly abnormal, such that binary classifications can be run on the tissue regions. The trained classifier may be stored, e.g., in storage devices 109.

In some examples, the supervised machine learning system may be trained using strong annotations (e.g. digital WSIs annotated with the kind(s) of tissue(s) present in the WSI). In such examples, the supervised machine learning system may include a convolutional neural network (CNN), a multi-layer perceptron (MLP), a support vector machine (SVM), a nearest neighbor algorithm model, or a random forest algorithm model, among other similar examples. To enable learning, one or more annotated digital WSIs, normal morphologies associated with the annotated digital WSIs, and/or abnormal morphologies associated with the annotated digital WSIs, may be provided as input to the machine learning system. The machine learning system may then output predicted abnormality scores for each of the foreground tiles. The predicted abnormality scores may be compared to corresponding binarized normal and/or abnormal morphologies to determine a loss or error. The corresponding normal morphologies may be a portion of a strong annotation of the training annotated digital WSIs that corresponds to a foreground tile and indicates normal tissue aspects of the foreground tiles. The machine learning system may be modified or altered (e.g., weights and/or bias associated with one or more nodes and/or layers may be adjusted) based on the error to improve an accuracy of the system. This process may be repeated for each of the training annotated digital WSIs received or at least until a determined loss or error is below a predefined threshold. In some examples, a portion of the training annotated digital WSIs may be withheld and used to further validate or test the machine learning system.

FIG. 11 illustrates an example system or device 1100 that may execute techniques presented herein. Device 1100 may include a central processing unit (CPU) 1120. CPU 1120 may be any type of processor device including, for example, any type of special purpose or a general-purpose microprocessor device. As will be appreciated by persons skilled in the relevant art, CPU 1120 also may be a single processor in a multi-core/multiprocessor system, such system operating alone, or in a cluster of computing devices operating in a cluster or server farm. CPU 1120 may be connected to a data communication infrastructure 1110, for example a bus, message queue, network, or multi-core message-passing scheme.

Device 1100 may also include a main memory 1140, for example, random access memory (RAM), and also may include a secondary memory 1130. Secondary memory 1130, e.g. a read-only memory (ROM), may be, for example, a hard disk drive or a removable storage drive. Such a removable storage drive may comprise, for example, a floppy disk drive, a magnetic tape drive, an optical disk drive, a flash memory, or the like. The removable storage drive in this example reads from and/or writes to a removable storage unit in a well-known manner. The removable storage may comprise a floppy disk, magnetic tape, optical disk, etc., which is read by and written to by the removable storage drive. As will be appreciated by persons skilled in the relevant art, such a removable storage unit generally includes a computer usable storage medium having stored therein computer software and/or data.

In alternative implementations, secondary memory 1130 may include similar means for allowing computer programs or other instructions to be loaded into device 1100. Examples of such means may include a program cartridge and cartridge interface (such as that found in video game devices), a removable memory chip (such as an EPROM or PROM) and associated socket, and other removable storage units and interfaces, which allow software and data to be transferred from a removable storage unit to device 1100.

Device 1100 also may include a communications interface (“COM”) 1160. Communications interface 1160 allows software and data to be transferred between device 1100 and external devices. Communications interface 1160 may include a modem, a network interface (such as an Ethernet card), a communications port, a PCMCIA slot and card, or the like. Software and data transferred via communications interface 1160 may be in the form of signals, which may be electronic, electromagnetic, optical or other signals capable of being received by communications interface 1160. These signals may be provided to communications interface 860 via a communications path of device 1100, which may be implemented using, for example, wire or cable, fiber optics, a phone line, a cellular phone link, an RF link or other communications channels.

The hardware elements, operating systems, and programming languages of such equipment are conventional in nature, and it is presumed that those skilled in the art are adequately familiar therewith. Device 1100 may also include input and output ports 1150 to connect with input and output devices such as keyboards, mice, touchscreens, monitors, displays, etc. Of course, the various server functions may be implemented in a distributed fashion on a number of similar platforms, to distribute the processing load. Alternatively, the servers may be implemented by appropriate programming of one computer hardware platform.

Throughout this disclosure, references to components or modules generally refer to items that logically may be grouped together to perform a function or group of related functions. Like reference numerals are generally intended to refer to the same or similar components. Components and/or modules may be implemented in software, hardware, or a combination of software and/or hardware.

The tools, modules, and/or functions described above may be performed by one or more processors. “Storage” type media may include any or all of the tangible memory of the computers, processors or the like, or associated modules thereof, such as various semiconductor memories, tape drives, disk drives and the like, which may provide non-transitory storage at any time for software programming.

Software may be communicated through the Internet, a cloud service provider, or other telecommunication networks. For example, communications may enable loading software from one computer or processor into another. As used herein, unless restricted to non-transitory, tangible “storage” media, terms such as computer or machine “readable medium” refer to any medium that participates in providing instructions to a processor for execution.

The foregoing general description is exemplary and explanatory only, and not restrictive of the disclosure. Other embodiments may be apparent to those skilled in the art from consideration of the specification and practice of the invention disclosed herein. It is intended that the specification and examples be considered as exemplary only.

What is claimed is:

1. A method for identifying morphologies present in digital whole slide images, the method comprising:
receiving one or more digital whole slide images associated with a patient;
determining a plurality of foreground tiles within the one or more digital whole slide images associated with a patient;
determining, using a trained machine learning model, whether each foreground tile of the plurality of foreground tiles contains a known morphology or an unknown morphology;
upon determining that one or more foreground tiles contains an unknown morphology, providing the one or more foreground tiles with an unknown morphology to a clustering algorithm, the clustering algorithm associating each of the one or more tiles with an unknown morphology cluster; and
based on the associated unknown morphology cluster, predicting at least one outcome for the patient.

2. The method of claim 1, wherein the one or more foreground tiles are determined by thresholding based on pixel variance, thresholding based on minimizing intra-class intensity variance, thresholding based on maximizing inter-class intensity variance, and/or comparing foreground tile pixel values to a reference foreground distribution.

3. The method of claim 1, wherein determining a plurality of foreground tiles within the one or more digital whole slide images associated with a patient further comprises normalizing the digital whole slide images for magnification levels.

4. The method of claim 1, wherein whether each foreground tile of the plurality of foreground tiles contains a known morphology or an unknown morphology is determined using an open-set classifier.

5. The method of claim 1, wherein the clustering algorithm uses a Mixture Model, a K-Means Model, agglomerative clustering, and/or an Expectation-Maximization Algorithm approach.

6. The method of claim 1, wherein providing the one or more foreground tiles to the clustering algorithm comprises:
determining a vector of features for each foreground tile with an unknown morphology, the clustering algorithm clustering a plurality of vectors associated with foreground tiles of unknown tissue morphology.

7. The method of claim 6, wherein the clustering algorithm may extract the plurality of vectors using hand-engineered features, pre-trained convolutional neural network (CNN) embeddings using supervised learning, pre-trained CNN embeddings using self-supervised learning techniques, or pre-trained transformer neural network features.

8. The method of claim 1, wherein predicting at least one outcome for the patient further comprises:
receiving patient data associated with the unknown morphology cluster; and
determining outcome data using the received patient data.

9. The method of claim 1, wherein the at least one outcome comprises at least one of a patient prognosis, a patient prognosis including years of survival, likelihood of response to medication, likelihood of recurrence, likelihood of metastasis, survival rate, effective medication type, effective treatment type, and a 5-year survival rate.

10. The method of claim 1, wherein the at least one outcome is predicted using a binary model based on presence of unknown tiles.

11. The method of claim 1, further comprising visualizing the one or more foreground tiles assigned to clusters to be analyzed by a medical professional.

12. The method of claim 1, further comprising correlating patient outcomes with the one or more clusters to predict prognosis based on the one or more clusters.

13. A system for identifying morphologies present in digital medical images, the system comprising:
at least one memory storing instructions; and
at least one processor configured to execute the instructions to perform operations comprising:
receive one or more digital whole slide images associated with a patient;
determine a plurality of foreground tiles within the one or more digital whole slide images associated with a patient;
determine, using a machine learning model, whether each foreground tile of the plurality of foreground tiles contains a known morphology or an unknown morphology;
upon determining that one or more foreground tiles contains an unknown morphology, provide the one or more foreground tiles with an unknown morphology to a clustering algorithm, the clustering algorithm associating each of the one or more tiles with an unknown morphology cluster; and
based on the associated unknown morphology cluster, predict at least one outcome for the patient.

14. The system of claim 13, wherein the one or more foreground tiles are determined by thresholding based on pixel variance, thresholding based on minimizing intra-class intensity variance, thresholding based on maximizing inter-class intensity variance, and/or comparing foreground tile pixel values to a reference foreground distribution.

15. The system of claim 13, wherein determining a plurality of foreground tiles within the one or more digital whole slide images associated with a patient further comprises normalizing the digital whole slide images for magnification levels.

16. The system of claim 13, wherein providing the one or more foreground tiles to the clustering algorithm comprises:
determining a vector of features for each tile with an unknown morphology, the clustering algorithm clustering a plurality of vectors associated with foreground tiles of unknown tissue morphology.

17. A non-transitory computer-readable medium storing instructions that, when executed by a processor, cause the processor to perform operations for identifying morphologies present in digital medical images, the operations comprising:
receiving one or more digital whole slide images associated with a patient;
determining a plurality of foreground tiles within the one or more digital whole slide images associated with a patient;
determining, using a machine learning model, whether each foreground tile of the plurality of foreground tiles contains a known morphology or an unknown morphology;
upon determining that one or more foreground tiles contains an unknown morphology, providing the one or more foreground tiles with an unknown morphology to a clustering algorithm, the clustering algorithm associating each of the one or more tiles with an unknown morphology cluster; and
based on the associated unknown morphology cluster, predicting at least one outcome for the patient.

18. The non-transitory computer-readable medium of claim 17, wherein the one or more foreground tiles are determined by thresholding based on pixel variance, thresholding based on minimizing intra-class intensity variance, thresholding based on maximizing inter-class intensity variance, and/or comparing foreground tile pixel values to a reference foreground distribution.

19. The non-transitory computer-readable medium of claim 17, wherein determining a plurality of foreground tiles within the one or more digital whole slide images associated with a patient further comprises normalizing the digital whole slide images for magnification levels.

20. The non-transitory computer-readable medium of claim 17, wherein providing the one or more foreground tiles to the clustering algorithm comprises:
determining a vector of features for each tile with an unknown morphology, the clustering algorithm clustering a plurality of vectors associated with foreground tiles of unknown tissue morphology.
